(19) United States
(12) Patent Application Publication
(10) Pub. No.: US 2008/0258869 A1
(43) Pub. Date: Oct. 23, 2008

(54) Electronic Key-Management System

(76) Inventor: Miodrag Ognjenovic, Portland, OR (US)

Correspondence Address: JOSEPH P. CURTIN, 1469 N.W. MORGAN LANE, PORTLAND, OR, 97229, US

(21) Appl. No.: 12/019,008

(22) Filed: Jan. 24, 2008

Related U.S. Application Data
(60) Provisional application No. 60/912,910, filed on Apr. 19, 2007.

(51) Int. Cl. G05B 19/00

(52) U.S. Cl. 340/5.73

(57) ABSTRACT

A device that is part of an electronic key-management system comprises an interface, and a key holder and key carrier device. The interface is capable of receiving a control signal from an external control system, such as a building access control system, a building security system, a building integration system, a building control system and by local manual control unit. The key holder device is capable of being responsive to the control signal received from the external management system by unsecuring a key associated with the key holder/carrier device. In one embodiment, the key associated with the key holder/carrier device comprises at least one wireless RF transponder capable of providing identification information associated with the key holder/carrier in response to an identification query.

### CROSS-REFERENCE TO RELATED APPLICATION

The present patent application claims priority to U.S. Provisional Patent Application Ser. No. 60/912,910, entitled “The Integration of Electronic Key Management System in Access Control, Security System, Building Integration System or Building Control System,” filed Apr. 19, 2007, and invented by Modrag Ognjenovic, the disclosure of which is incorporated by reference herein.

### BACKGROUND

The primary purpose of an electronic key-management system is to protect keys and to organize key management. Many available electronic key-management systems are designed as standalone systems and utilize proprietary software integrated for their specific key-management applications without the capability for integration with other external systems such as conventional access control, security systems, and/or building control systems and without the capability of managing the individual keys with their control units.

U.S. Pat. No. 6,315,198 B1 to Lenglart et al. discloses an access control system comprising a key cabinet. According to one embodiment disclosed by the Lenglart et al. patent, when user credentials are presented to a reader. A decision is made by decision making equipment ED based on the presented user credentials for determining whether the door to the key cabinet should be opened. The key cabinet includes an examination circuit SC that monitors the state of a plurality of key contacts in a matrix device MC in the key cabinet for determining whether a change of state associated with the key contacts has occurred. When a change of state is detected, a virtual badge number is generated corresponding to the change of state, the state of the processed key is stored, and the virtual badge number is transferred to the decision making equipment ED. According to another embodiment disclosed by the Lenglart et al. patent, the virtual badge number is compiled in a chronological list in order to log the actions carried out in the key cabinet.

### BRIEF DESCRIPTION OF THE DRAWINGS

The subject matter disclosed herein is illustrated by way of example and not by limitation in the accompanying figures in which like reference numerals indicate similar elements and in which:

FIG. 1 depicts an exemplary embodiment of an electronic key-management system according to the subject matter disclosed herein;

FIG. 2 depicts a more detailed view of internal panel wall according to the subject matter disclosed herein;

FIGS. 3A and 3B respectively depict a side view and a bottom edge view of an exemplary electronics module according to the subject matter disclosed herein;

FIG. 4 shows a flow diagram illustrating one exemplary operational flow utilizing a key-management system according to the subject matter disclosed herein in a conventional external access control system; and

FIG. 5 shows a process diagram corresponding to the exemplary operational flow diagram of FIG. 4.

### DETAILED DESCRIPTION

As used herein, the word “exemplary” means “serving as an example, instance, or illustration.” Any embodiment described herein as “exemplary” is not necessarily to be construed as preferred or advantageous over other embodiments.

The subject matter disclosed herein provides a key-management system that integrates with variety of external systems and is capable of being controlled by outputs of an external access control, building control systems, building security systems, building integration systems, and/or a manual control unit. The subject matter disclosed herein allows a user and/or an administrator of an access control system (or other external control system) to control the usage of the each individual key/key carrier a key-management system by a database of an existing access control system that already contains user credential information, schedules, security levels, etc. Thus, the user and/or administrator are/is not required to duplicate the database as would be required for a separate conventional key-management system. Moreover, the subject matter disclosed herein provides that a system administrator not be required to learn separate software and maintain a separate data base and other security settings.

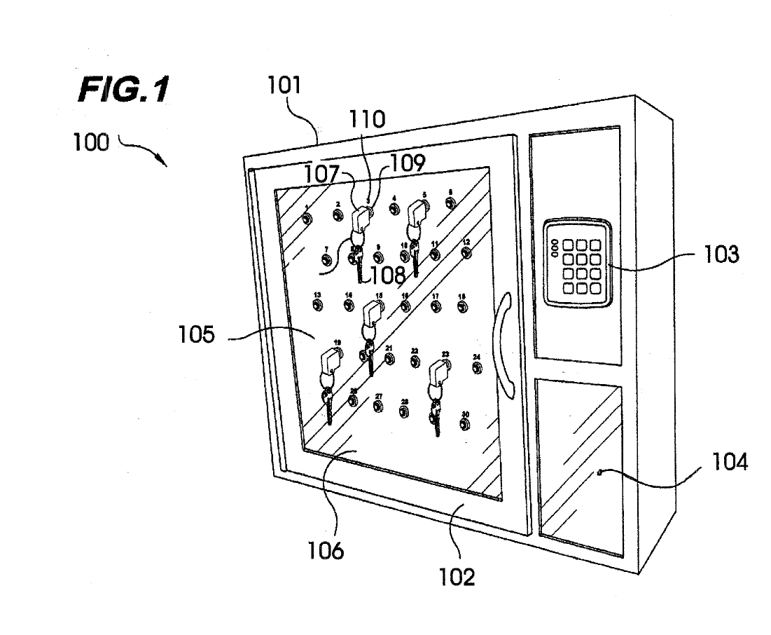

FIG. 1 depicts an exemplary embodiment of an electronic key-management system 100 according to the subject matter disclosed herein. System 100 comprises a key cabinet 101, an access door 102, a credential input device 103, a secure portion 104 within key cabinet 101, and an internal panel wall 105. In one exemplary embodiment, key cabinet 101 could be integrated into a single external access control system (not shown). In another exemplary embodiment, several key cabinets 101 could be integrated with one external access control system (not shown). In yet another exemplary embodiment, a key cabinet 101 could be integrated with a plurality of external access control systems (not shown).

Key cabinet 101 contains and protects keys, key carriers, electronic modules, power supplies, wiring, and connections to an external access control system. Accordingly, key cabinet 101 could be designed for mounting on a wall or surface or for in-wall installation. Depending on the particular environment and key-management application provided by system 100, key cabinet 101 could be made from steel, stainless steel, plastic, and/or aluminum, and could be powder coated, galvanized and/or painted.

Access door 102 provides secure lockable access to keys and key holders contained in key cabinet 101. In one exemplary embodiment, access door 102 comprises an unbreakable transparent panel 109, such as Plexiglas, that provides visibility of keys and other items contained in key cabinet 101. In another exemplary embodiment, access door 102 provides no visibility of the keys contained in key cabinet 101.

Credential input device 103 permits a user to input credentials of the user for gaining controlled access to keys and other items contained in key cabinet 101. In one exemplary embodiment, credential input device 103 comprises a keypad that allows a user to enter in a well-known manner a Personal Identification Number (PIN) associated with the user. In another exemplary embodiment, credential input device 103 comprises a biometric reader that reads in a well-known manner a biometric of the user, such as, but not limited to, a fingerprint, an iris pattern, a hand characteristic, a face characteristic and/or a voice characteristic. In yet another exemplary embodiment, credential input device 103 receives identification information of a user in a well-known manner via a radio-frequency (RF) or an infrared (IR) link from a corresponding transmitter. In still another exemplary embodiment, credential device 103 receives identification information of a user via an audio input device, such as a microphone, and/or an imaging device, such as a camera or a video imaging device. It should be understood that credential input device 103 could be part of an external access control system or a building control system (both not shown). It should also be understood that a plurality of different credential input devices could be used for inputting credentials of a user for gaining controlled access to keys/key holders contained in key cabinet 101. Additionally, it should be understood that credential input device 103 is securely installed in key cabinet 101 in a well-known manner to be protected to prevent tampering, but credential input device 103 also could be installed in a wall or in specially designed holders to accommodate building access control requirements.

One exemplary embodiment of secure portion 104 within key cabinet 101 provides restricted access to components such as, but not limited to, wiring, power supplies, batteries, control and support components that are used for the operation of electronic key-management system 100, and connection and junction panels for internal connections and for connections with at least one external access control system.

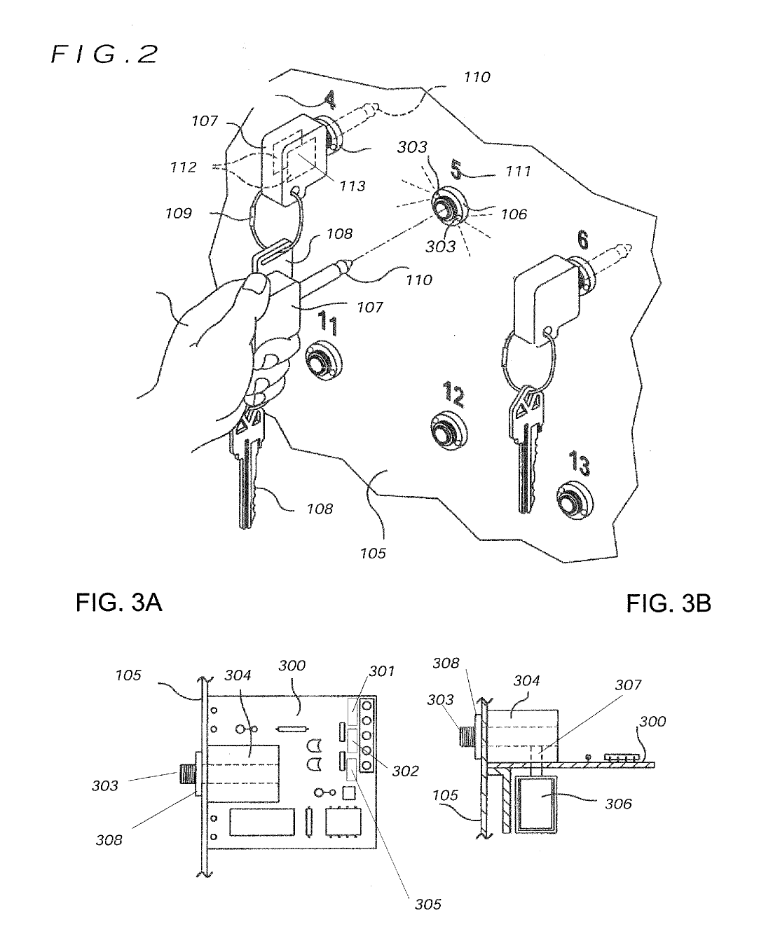

Internal panel wall 105 comprises at least one key position 106. In one exemplary embodiment, internal panel wall 105 comprises between five and 250 key positions 106. It should be understood that internal panel wall 105 could have any number of key positions 106. It should also be understood that internal panel wall 105 could also provide positions for other items, such as, but not limited to, identification (ID) cards and data-storage media. FIG. 2 depicts a more detailed view of internal panel wall 105 according to the subject matter disclosed herein. Each key position 106 comprises components that are capable of accepting and retaining a key carrier 107. Key carrier 107 is designed to securely hold an attached key 108 in an electronic module 300 (shown in FIGS. 3A and 3B). In one exemplary embodiment, key 108 is attached to key carrier 107 using an aircraft cable with locking mechanism 109, or with other well-known secure attachment device. One exemplary embodiment of key carrier 107 comprises an extended-plug portion 110 and could be made from metal and/or plastic depending on the particular environment and application. Extended-plug portion 110 is sized and shaped to fit into a hole 303 of a holder 304 (FIGS. 3A and 3B) on an electronic module 300, and is shaped to lockingly engage a plunger 307 of a locking mechanism 306 that is located on the electronic module. In one exemplary embodiment, each key position 106 is indicated by a referenced designator 111, such as a number or a letter

One exemplary embodiment of key carrier 107 comprises an imbedded wireless ID transponder 112, such as an RF ID transponder or an infrared ID transponder, which identifies each key carrier 107 in a well-known manner using specific identification information and a selected communication protocol. In one exemplary embodiment, the identification information is unique within the domain of the access control system. In another exemplary embodiment, the identification information is universally unique. In one exemplary embodiment, imbedded wireless ID transponder 112 allows a user to unlock key cabinet door 102 and the key position corresponding to a key holder by presenting the key holder to the credential input device 103 when returning the key to the key cabinet. Additionally, a key carrier 107 comprising an imbedded wireless transponder 112 could also be used as an access pass for an existing access control system to unlock any assigned door, call an elevator, unlock a gate, etc., within a facility that is authorized for the particular key holder. An imbedded wireless transponder 112 in a key carrier 107 can also permit tracking and determination of the position of each key carrier within a facility, along with being capable of causing an alarm to be triggered when the key holder approaches an exit or a critical protected point within a facility. In another exemplary embodiment, key carrier 107 comprises a plurality of imbedded RF ID transponders 112, 113 that are capable of communicating in different RF ID protocols thereby permitting short- and long-range and/or secure communications capability with sensors of an external access control system without interference between the different communications protocols associated with the different transponders. The passive/active electronic element(s) required by the external system, such as resistors, diodes, transistors, etc. also could be imbedded in the key carrier, so the external access control system through inputs that are connected with electronic module can detect a presence of a correct type of key carrier in the electronic module, thereby eliminating the possibility that a similar-shaped object could be returned in the place of the key carrier.

FIGS. 3A and 3B respectively depict a side view and a bottom edge view of an exemplary electronics module 300 according to the subject matter disclosed herein. An electronic module 300 is associated with a key position 106 and monitors the presences of a key carrier 107, locks and unlocks (secure and unsecure) a key carrier 107 and executes command and/or functions received from an external access control system (not shown). In one exemplary embodiment, an electronic module is associated with a single key position 106. In another exemplary embodiment, an electronic module is associated with one or more key positions 106. In one exemplary embodiment, electronic module 300 is mounted in key cabinet 101 behind internal panel 105 in a well-known manner so that electronic module is not removable, is inaccessible to a user and is tamper proof.

Electronic module 300 is capable of interfacing with variety of outputs of conventional external access control systems, for example, but not limited to, open collector outputs 301, relay outputs 302, dry contact relay outputs 305. Additionally, electronic module 300 could contain a signal inverter and/or a timer for accommodating an interface with variety of other types of systems outputs. It should be understood that electronics module could additionally and/or alternatively interface with an external access control system through a wireless communication link, such as an RF link and/or an infrared link. One exemplary embodiment of electronic module 300 comprises a holder 304, a locking solenoid 306, and other appropriate components depicted in FIGS. 3A and 3B for interfacing and processing commands and signals received from an output of external access control system (not shown). Holder 304 comprises a hole 303 that is sized and shaped for accommodating the extended-plug portion 110 of key carrier 107. In one exemplary embodiment, electronic module 300 comprises an LED 308 that when illuminated visually indicates an unlocked key position 106 and/or the presence of the key carrier 107.

When key carrier 107 is plugged into hole 303 for the holder on electronic module 300, a plunger 307 of solenoid 306, which is shaped to lockingly engage the shape of extended-plug portion 110, locks (or secures) key carrier 107 in a holder 304, and keeps key carrier 107 locked (or secured) until a signal and/or command from an external access control system is received. Electronics module 300 is responsive to the signal and/or command received from the external access control system by controlling solenoid 306 for a predetermined amount of time to unlock key carrier 107. In one exemplary embodiment, electronic module 300 is responsive to a signal from a manual external control device. In another exemplary embodiment, LED 308 is energized and visually indicates the unlocked key carrier 107. The particular unlocked key carrier 107 can then readily be identified among a plurality of key carriers 107. In one exemplary embodiment, LED 308 is a two-color LED, such as red and green with red indicating a locked (secured) key holder state and green indicating an unlocked (unsecured) key holder state. It should be understood that various combinations of lit/unlit LEDs and colors could be used for indicating one of a plurality of key holder states. Additionally or alternatively, holder 304 can sense in a well-known manner whether a key carrier is held by holder 304 and the sensed state of the key holder can be visually indicated by LED 308. Further still, the sensed state can be communicated in a well-known manner from electronics module 300 to an external access control system.

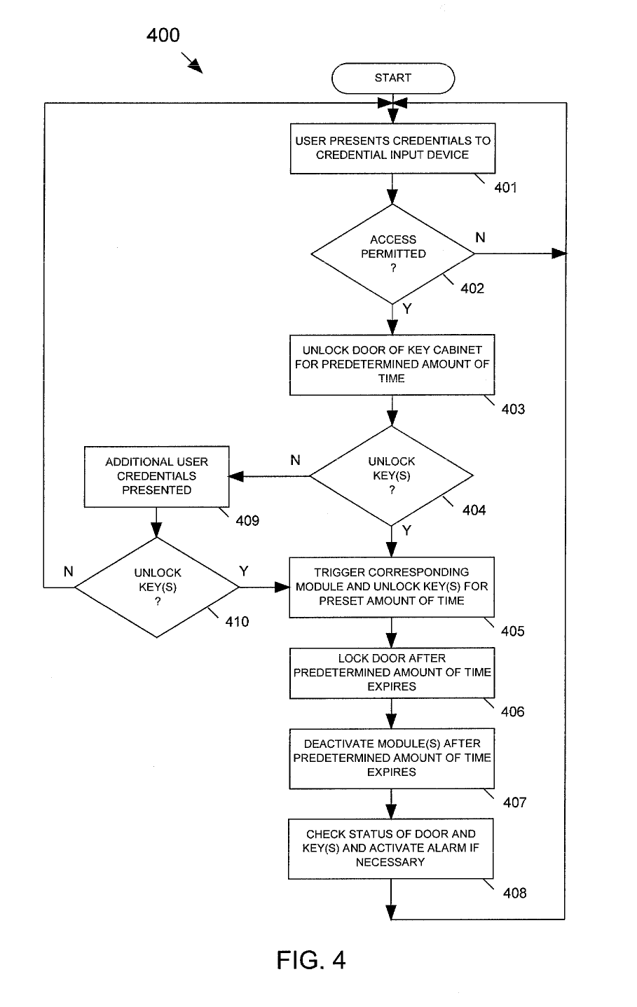

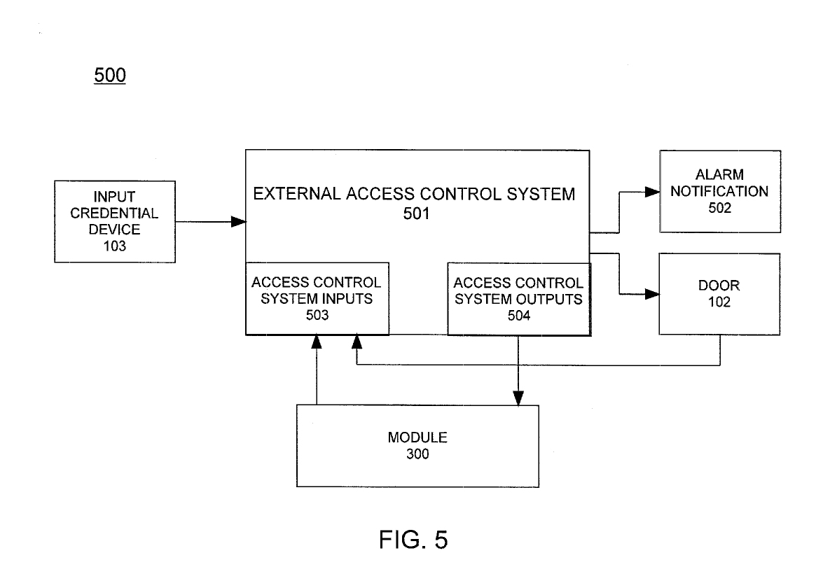

FIG. 4 shows a flow diagram 400 illustrating one exemplary operational flow utilizing of a key-management system according to the subject matter disclosed herein in a conventional external access control system. FIG. 5 shows a process diagram 500 corresponding to the exemplary operational flow diagram of FIG. 4.

At step 401 in FIG. 4, a user presents credentials to credential input device 103 for opening cabinet door 102 and/or for unlocking one or more keys and/or contents contained within key cabinet 101. As shown in FIG. 5, credential input device 103 provides the user credentials to an external access control system 501. At step 402, the external access control system determines whether the credentials that have been presented allow that the cabinet door 102 be permitted to be unlocked, or that the cabinet door 102 and the particular external access control output associated with particular key position will be activated. In the exemplary embodiment shown in FIG. 4, the user brings a key carrier 107 that includes an RF ID transponder near to an RF reader (i.e., a credential input device 103) so that the user can return the key carrier to its appropriate position 106 in key cabinet 101. In such a situation, the external access control system activates the corresponding output, which unlocks door 102 and triggers the electronics module 300 associated with the corresponding key position by activating solenoid 106, thereby enabling the key carrier to be returned to the key position. For this embodiment, all other positions 106 with or without key carriers 107 remain locked, thereby eliminating the possibilities that the wrong key carrier could be returned to the wrong position or that another key carrier could be taken without authorization. Additionally, electronics module 300 can illuminate an LED 308 associated with the electronics module so that the user can readily identify the appropriate position 106 for a returned key carrier.

If, at step 402, external access control system 501 determines that the credentials of the user permit cabinet door 102 to be unlocked, flow continues to step 403 where external access control system 501 unlocks cabinet door 102 for a predetermined amount of time. If, at step 402, external access control system 501 determined that the credentials of the user do not permit cabinet door 102 to be unlocked, cabinet door 102 remains locked and flow returns to step 401.

After step 403, flow continues to step 404 where it is determined by external access control system 500 whether the credentials of the user that have already been presented allow one or more keys to be unlocked. If, at step 404, it is determined by external access control system 501 that the credentials of the user allow one or more keys to be unlocked (unsecured), flow continues to step 405 where access control outputs 504 corresponding to the credentials are activated, thereby triggering the electronic module(s) through the access control system outputs 504 (FIG. 5) and unlocking the particular key position(s). (It should be noted that FIG. 5 shows only one module 300 for clarity, but it should be understood that more that one module 300 could be triggered by external access control system 501.)

Flow continues to step 406 where external access control system 501 locks the cabinet door 102 after the predetermined amount of time expires, and deactivates the outputs to module(s) 300 after the predetermined amount of time expires at step 407. At step 408, the external access control system checks the status of the door and if the door is still open after the predetermined amount of time has expired, the external access control system activates an alarm notification 502. Additionally, the external access control system checks the status inputs received from module(s) 300 through access control system inputs 503 (FIG. 3). If the status of a module 300 is not the value required by external access control system 501, external access control system 501 activates the alarm notification 502. If the status of the door is closed and the status of the key(s) is correct, flow returns to step 401 waiting for another input of user credentials.

Also if, at step 404, it is determined by external access control system 501 that the credentials of the user allow one or more keys (and/or items of the contents contained in cabinet 101) to be unlocked, the external access control system unlocks the cabinet door 102 and flow continues to step 409 where additional user credentials are presented to credential input device 103. Flow continues to step 410 where it is determined by external access control system 501 whether the additional user credentials that have been presented allow one or more keys (and/or items of the contents contained in cabinet 101) to be unlocked. If so, flow continues to step 405, which is described above. If not, flow returns to step 401.

When an electronic module 300 receives a trigger signal and/or command from an external access control, the electronic module responds by unlocking the associated key carrier 107. In one exemplary embodiment, after the key carrier is removed from an unlocked position, the corresponding electronic module will sense in a well-known manner that the key carrier is not in its designated position and an LED will be energized that visually indicates that the particular key carrier is not in its designated position. In another exemplary embodiment, the electronic module will send a signal to the input module of the external access control system to indicate that the particular key carrier is not in its designated position, which allows a system administration to review and monitor the respective keys stored in key cabinet 101.

A user may have credentials that allow several key carriers to be removed based on one credential query to the external access control system. In one exemplary embodiment, the external access control system activates outputs that activate the corresponding electronic module(s) so that solenoids 306 are energized and that the associated key carrier(s) 107 are unlocked for a predetermined period of time. At the end of the predetermined period of time, the electronic module de-energizes the solenoid, and/or the external access control deactivates the outputs, thereby relocking the associated key holder if the key holder has not yet been removed. In another exemplary embodiment, the electronic module unlocks the key carrier until the external access control system senses in a well-known manner that the key carrier has been removed. Further, one exemplary embodiment provides that an LED for each unlocked key carrier is energized so that a user can readily identify the unlocked key carriers.

Although the foregoing disclosed subject matter has been described in some detail for purposes of clarity of understanding, it will be apparent that certain changes and modifications may be practiced that are within the scope of the appended claims. Accordingly, the present embodiments are to be considered as illustrative and not restrictive, and the subject matter disclosed herein is not to be limited to the details given herein, but may be modified within the scope and equivalents of the appended claims.

What is claimed is:

1. A device, comprising:
an interface module capable of receiving of a control signal from an external access control system; and
a key-holder device capable of being responsive to the control signal received from the access management system by unsecuring a key associated with the key holder device.

2. The device according to claim 1, wherein the external access control system comprises one of a building access control system, a building security system, a building integration system, and a building control system.

3. The device according to claim 1, wherein the interface module comprises at least one signal converter for at least one of a positive and a negative input, and timer.

4. The device according to claim 1, wherein the interface module comprises at least one of an open collectors input, and a dry contact relay input.

5. The device according to claim 1, wherein the interface module comprises one of an RF input and an infrared input.

6. The device according to claim 1, further comprising the key associated with the key holder device.

7. The device according to claim 6, wherein the key comprises a key carrier comprising at least one wireless RF transponder capable of providing identification and tracking information associated with the key carrier in response to an identification query.

8. The device according to claim 1, wherein the key comprises a key carrier,
wherein the key-holder device comprises a space capable of holding the key carrier, and
the device further comprising a sensor capable of sensing whether the key carrier is positioned within the space of the key-holder device, and capable of outputting a signal indicative of whether the key carrier is sensed within the space of the key-holder device.

9. The device according to claim 8, further comprising a visual indicator device that is responsive to the signal indicative of whether the key carrier is sensed within the space of the key-holder device by indicating whether the key carrier is sensed within the space of the key-holder device.

10. The device according to claim 1, further comprising a visual indicator device that is responsive to the control signal by indicating a state of the key-holder device.

11. The device according to claim 1, wherein the device is part of a key-management device.

12. A device, comprising:
an interface module capable of receiving of a control signal from an external access control system, the external access control system being external to the device;
a key device comprising a key and a key carrier;
a securing mechanism capable of receiving the key carrier in a locking space, the securing mechanism being further capable of securing the key carrier in the locking space, and unsecuring the key carrier from the locking space, and being responsive to the control signal received by the interface module by unsecuring the key carrier from the locking space;
a sensor capable of sensing whether the key carrier has been received by the locking space, and capable of outputting a signal indicative of whether the key carrier has been sensed as being received by the locking space;
a first visual indicator device responsive to the signal indicative of whether the key carrier has been received by the locking space by providing a visual indication of whether the key carrier has been received by the locking space; and
a second visual indicator device that is responsive to the control signal received by the interface module by indicating a secured/unsecured state of the securing mechanism.

13. The device according to claim 12, further comprising a timer capable of being responsive to the control signal received by the interface module by generating a timer signal a predetermined period of time after the control signal is received by the interface module, and
wherein the locking mechanism is further capable of being responsive to the timer signal by changing from an unsecured state to a secured state.

14. The device according to claim 13, wherein the key carrier comprises at least one wireless RF transponder capable of providing identification and tracking information associated with the key carrier in response to an identification query.

15. The device according to claim 14, wherein the interface module comprises at least one of an open collectors input, a dry contact relay input, an RF input and an infrared input.

16. The device according to claim 15, wherein the device is part of a key-management device.

17. The device according to claim 16, wherein the external access control system comprises one of a building access control system, a building security system, a building integration system, and a building control system.

18. A device comprising a key carrier capable of being associated with a key, the key carrier comprising at least one wireless RF transponder capable of providing identification and tracking information associated with the key carrier in response to an identification query.

19. The device according to claim 18, further comprising:
an interface module capable of receiving of a control signal from an external access control system; and
a key-holder device capable of securing the key carrier and capable of being responsive to the control signal received from the access management system by unsecuring the key carrier.

20. The device according to claim 19, further comprising the key associated with the key carrier, and
wherein the external access control system comprises one of a building access control system, a building security system, a building integration system, and a building control system.
